(19) United States
(12) Patent Application Publication
(10) Pub. No.: US 2013/0189560 A1
(43) Pub. Date: Jul. 25, 2013

(54) Materials And Methods For Joining Battery Cell Terminals And Interconnector Busbars

(71) Applicant: Humi Widhalm, Northville, MI (US)

(72) Inventor: Humi Widhalm, Northville, MI (US)

(73) Assignee: FORD GLOBAL TECHNOLOGIES, LLC, Dearborn, MI (US)

(21) Appl. No.: 13/353,746

(22) Filed: Jan. 19, 2012

(51) Int. Cl. H01M 2/26; H01M 6/00

(52) U.S. Cl. 429/121; 29/623.5

(57) ABSTRACT

In one embodiment, a battery cell terminal includes a terminal substrate; an interconnector busbar including a busbar substrate; and a coating disposed between and contacting at least one of the terminal and busbar substrates, the coating including a metal and having a melting temperature smaller than a melting temperature of the terminal or busbar substrate. In another embodiment, the coating includes a first coating of a metal M1 and second coating of a metal M2, the first coating contacting the terminal substrate, and the second coating contacting the busbar substrate.

### TECHNICAL FIELD

The present invention relates to material and method for joining battery cell terminals and interconnector busbars.

### BACKGROUND

In electric vehicles (EV), high-voltage (HV) battery pack(s) consist of tens of battery modules which are interconnected electrically and thermally. Each battery module may include a number of battery cells and cooling plates or fins that are stacked in a structural framework and interconnected electrically by joining the battery cell terminals to interconnector busbars and thermally by coolant distribution manifold(s).

Several methods have been used in the art to promote joining of the battery cell terminals and the interconnector busbars, including ultrasonic welding, resistance spot welding, soldering, and others. However, these techniques have limitations which render the techniques not suitable for joining the battery cell terminals and corresponding interconnector busbars. Alternative joining techniques are needed to lower input energy requirement, ensure uniform and consistent joints across multiple layers, extend tool life, and/or minimize sensitivities of joint quality to variations of sheet metal terminals, Interconnector busbars, and/or their coatings.

### SUMMARY

In one aspect, a battery cell module is provided. In one embodiment, a battery cell module comprising: a battery cell terminal including a terminal substrate, an interconnector busbar including a busbar substrate; and a coating disposed between and contacting at least one of the terminal and busbar substrates, the coating including a metal and having a melting temperature smaller than a melting temperature of the terminal or busbar substrate.

In another embodiment, the coating includes a first coating of a metal M1 and second coating of a metal M2, the first coating contacting the terminal substrate, and the second coating contacting the busbar substrate. In certain instances, the terminal substrate has a melting temperature greater than a melting temperature of the first coating, the battery cell terminal being connected to the interconnector busbar via one or more M1-M2 metallurgical bonds. In certain other instances, the busbar substrate has a melting temperature greater than a melting temperature of the second coating, the battery cell terminal being connected to the interconnector busbar via one or more M1-M2 metallurgical bonds. In certain instances, the coating contacts a fraction of a total surface of the terminal substrate or the busbar substrate.

In yet another embodiment, the battery cell module further includes a conversion coating positioned between a terminal substrate surface and the first coating. In yet another embodiment, the battery cell module further includes a diffusion-barrier coating positioned between a terminal substrate surface and the first coating.

In yet another embodiment, the battery cell module further includes a second battery cell terminal connected to the first battery cell terminal such that the first battery cell terminal is positioned between the second battery cell terminal and the interconnector busbar.

In another aspect, a method is provided for forming a joint between a battery cell terminal and an interconnector busbar. In one embodiment, the method includes disposing a coating between a terminal substrate of the battery cell terminal and a busbar substrate of the interconnector busbar, the coating having a melting temperature smaller than a melting temperature of the terminal substrate or the busbar substrate; and subjecting the coating to heat to join the terminal substrate and the busbar substrate. In certain instances, the heat is provided by hot plates or electrode plates.

In another embodiment, the subjecting step includes heating the first and second coatings to a temperature greater than the higher of a melting temperature of the first coating and a melting temperature of the second coating to cause both the first and second coatings to become molten. In certain instances, the heating is carried out for a period of time. In certain other instances, the method further includes holding the heating at a constant temperature for an additional period of time.

In another embodiment, a hot plate power rating for the set of hot plates is determined according to Equation (1):

$${V}_{Comp} {ρ}_{Comp} {c}_{pComp} \frac{d {T}_{Comp}}{d t} = 2 {A}_{Comp} {h}_{HotPlate} ( {T}_{HotPlate} - {T}_{Comp} ) - \frac{{T}_{Comp} - {T}_{Air}}{{R}_{Total}} \qquad ( 1 )$$

Wherein: _{Comp} stands for volume (m³) of battery cell terminals and Interconnector busbar enclosed by hot plates; ρ_{Comp} stands for average density of V_{Comp} in kg/m³; c_{pComp} stands for average thermal capacity of V_{Comp} in J/kg K; T_{Comp} stands for average temperature of V_{Comp} in K; t stands for time in s; A_{Comp} stands for contact area (m²) between a hot plate and a battery cell terminal or Interconnector busbar; h_{HotPlate} stands for heat transfer coefficient (W/m²K) between a hot plate and a battery cell terminal or Interconnector busbar on the contact area; T_{HotPlate} stands for surface temperature (K) of a hot plate at the contact interface; T_{Air} stands for room temperature (K); and R_{Total} stands for total thermal resistance (K/W) from battery cell terminal through cell to cell surfaces.

### BRIEF DESCRIPTION OF THE DRAWINGS

FIG. 1 depicts a battery cell module according to one embodiment;

FIG. 2A depicts a planar view of a battery cell of the battery cell module of FIG. 1;

FIG. 2B depicts a side view of an electroplating device for applying a coating onto a cell terminal of the battery cell module of FIG. 1;

FIG. 2C depicts a perspective view of a roll of coated material to be blanked to form the cell terminal of the battery cell module of FIG. 1;

FIG. 3A depicts a perspective view of an Interconnector busbar of the battery cell module of FIG. 1;

FIG. 3B depicts a side view of an electroplating device for applying a coating onto an Interconnector busbar of the battery cell module of FIG. 1;

FIG. 3C depicts a perspective view of a roll of coated material to be blanked to form the Interconnector busbar of the battery cell module of FIG. 1;

FIGS. 4A to 4B depict various views of a battery cell module of FIG. 1, before, during, and after the Interconnector busbar is assembled onto the cell terminals;

FIG. 5 depicts a battery cell with terminals within the context of being subject to a set of hot plates according to another embodiment;

FIG. 6A depicts a perspective view of a terminal-busbar composite including three terminals grouped together next to a Interconnector busbar according to yet another embodiment;

FIG. 6B depicts a side view of the terminal-busbar composite of FIG. 6A being sandwiched within a pair of hot plates according to yet another embodiment;

FIG. 6C depicts a side view of the terminal-busbar composite of FIG. 6A being sandwiched within a pair of electrode plates according to yet another embodiment; and

FIG. 7 depicts structural protrusions for conducting heat.

### DETAILED DESCRIPTION

As required, detailed embodiments of the present invention are disclosed herein. However, it is to be understood that the disclosed embodiments are merely exemplary of the invention that may be embodied in various and alternative forms. Therefore, specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in the description and in the claims are to be understood as modified by the word “about” in describing the broader scope of this invention. Also, unless expressly stated to the contrary, the description of a group or class of material is suitable or preferred for a given purpose in connection with the invention implies that mixtures of any two or more members of the group or class may be equally suitable or preferred.

Several methods have been used in the art to promote joining of the battery cell terminals and the interconnector busbars. For instance, laser welding is one method. Laser welding may be suitable for thin seam joining and tiny spot joining of same metals in an open space. A thin seam and/or tiny spot joints may pose the problem of high electrical resistance in battery applications. Increasing numbers of seams or spots increases the process cycle time. Laser welding joins mating metal surfaces by locally melting the metals using focused energy from a laser beam which may form brittle intermetallics and heat-affected-zone (HAZ). Brittle intermetallic may adversely affect mechanical and electrical properties of the joints, notably in the formation of creep and interfacial resistance, resulting in reduced durability, and power loss and heat buildup during operation. For joining battery cell terminals to interconnector busbars made of same or dissimilar sheet metals with higher-melting-temperature coatings, it may be particularly challenging, if not all impossible, to use laser welding in a multilayer configuration. The high melting temperatures of the metals/coatings require high processing temperatures which may destroy or degrade the neighboring materials. Prolonged heating up increases the process cycle time. The confined space between interconnector busbars may also require complicated tooling and use of fiber Laser. When thermally conductive materials such as aluminum or copper are used, laser welding becomes even more challenging to be used.

For instance also, resistance spot welding uses two shaped copper-alloy electrodes to clamp metal sheets while a large electric current is forced through the small contacting spot. Heat created from the electrical resistance of metal sheets melts the metals at the spot and forms a spot weld. A lot of energy may be delivered to the spot in a very short time, in the neighborhood of a few milliseconds, allowing welding to occur without excessive heating to the rest of the metal sheets. A modification of resistance spot welding, projection welding involves heat created from the electrical resistance of metal sheets wherein the heat is concentrated at raised projections on one or both of the metal sheets, allowing welding of heavier sections or closer spacing of welds. Like laser welding, resistance spot welding similarly experiences the issues due to heating and melting of metals. In addition, the confined space between interconnector busbars creates the same challenge in tool/fixture engineering and automation. Although the spots from the resistant spot welding may be much bigger than from laser welding, multiple spots may still be required for a minimal interfacial resistance, which further increases process cycle time.

For instance also, brazing requires a high process temperature, a flux and a brazing filler metal (BFM) which forms alloys with mating metal surfaces and may form brittle intermetallics. In addition, heating up and cooling down increase the process cycle time.

For instance also, fastening/riveting is a relatively simple joining methods and relatively easy to automate. However, for battery cell terminals and interconnector busbars in a multilayer sheet metal configuration, the confined space and the large number of tiny fasteners/rivets required render this method not very practical. The required force is high for riveting HS sheet metal terminals to interconnector busbars. In addition, fasteners/rivets add additional weight to battery modules. Although Riveting may be a good candidate for joining battery cell tabs to terminals in an open space due to its simplicity and lower tooling cost as compared to laser or ultrasonic welding, fastening/riveting may be a very practical solution for joining battery cell terminals to interconnector busbars in a multilayer sheet metal configuration and within a confined space.

For instance also, clinching/crimping joins two or more layers of sheet metals by localized cold-forming of the metals to produce an interlock among them. It is believed, however, that clinching/crimping suffers from the same drawbacks as ultrasonic welding, notably, often requiring prohibitively high mechanical energy for joining multiple layers of sheet metal materials and thus resulting short tool life. Multiple clinching/crimping interlocks result in longer cycle time and a confined space also limits the application of clinching/crimping.

For instance also, soldering requires a flux and a filler metal (solder) to join two or more metal surfaces by melting and flowing the solder into the joint. However, soldering temperatures, such as 215 ° C. or less for Pb solder and 245 ° C. or less for Pb-free solder, are much lower than brazing. Compared to most welding processes, soldering does not melt the base metals to be joined, but instead, bond the metals by wetting actions. Thus, the resulting joints are not as strong as the base metals, but have adequate strength and electrical conductivity for a wide range of electrical applications. For joining battery cell terminals to interconnector busbars in a multilayer sheet metal configuration and within a confined space, spot or seam/edge soldering using an iron and solder wire may not be robust, and reflow of solder paste or film involves many process steps, fixtures and a reflow oven. Both require fluxing, pre-heating and post-cooling, and thus long cycle time to complete. Extensive developments are needed to make soldering a viable solution for joining battery cell terminals to interconnector busbars in a multilayer sheet metal configuration and within a confined space.

The present invention, in one or more embodiments, is believed to provide a system and method in the area of joining the battery cell terminals and corresponding interconnector busbars, with benefits and/or improvements not otherwise realized in the art.

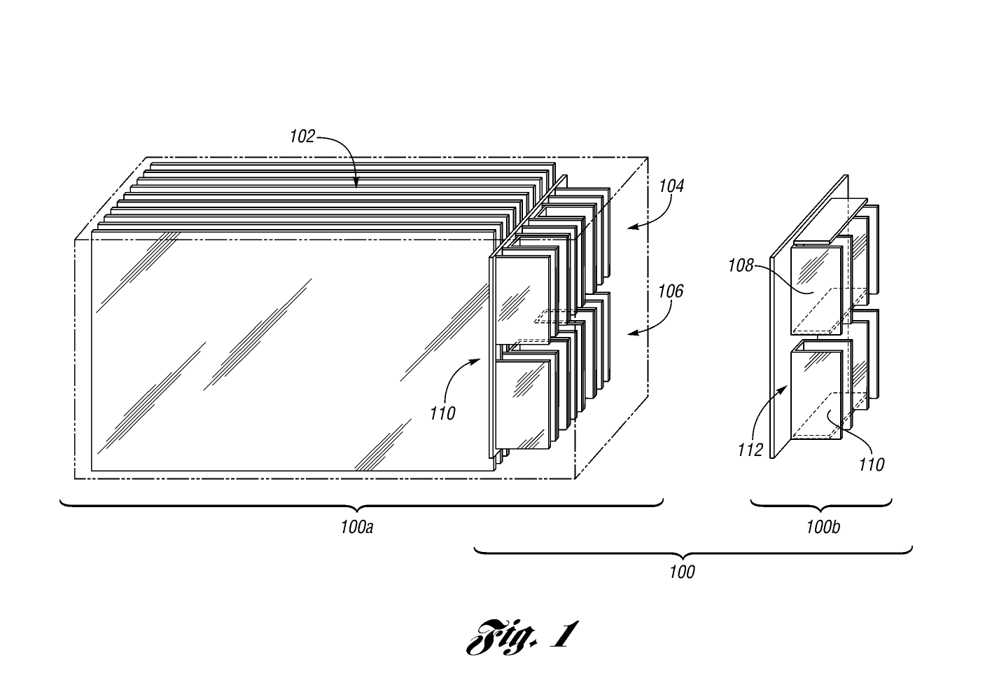

In one aspect, a battery cell module is provided. In one embodiment, and as depicted in FIG. 1, a battery cell module 100 includes a battery cell stack 100a and an interconnector busbar 100b. The battery cell stack 100a includes one or more battery cells 102, each including a positive terminal 104 and a negative terminal 106. One or more, and two to three in particular, of adjacent positive terminals 104 may be collectively received within a single interconnector busbar 108. One or more, and two to three in particular, of adjacent negative terminals 106 may be collectively received within a single interconnector busbar 110. The interconnector busbars 108 and 110 may be identical both in shape and material. However, certain variations may be introduced without having to sacrifice the intended purpose of these busbars. In certain particular instances, the positive terminals 104 may be formed of aluminum sheet/foils, and the negative terminals 106 may be formed of copper sheet/foils.

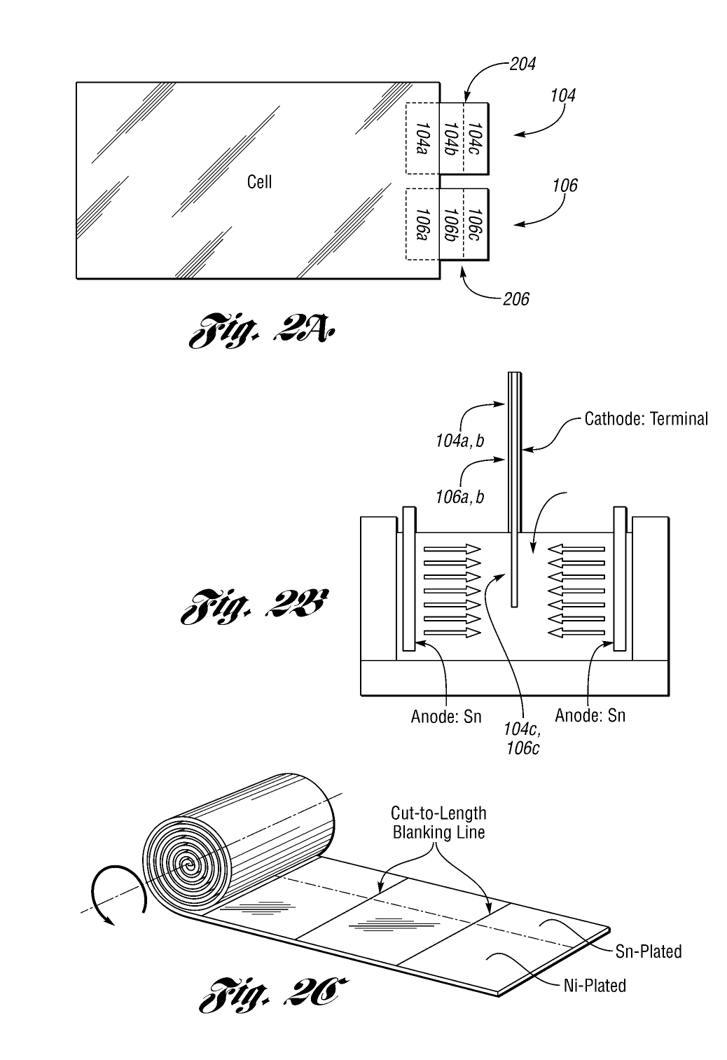

FIG. 2A depicts a planar view of a single battery cell 102 with corresponding terminals referenced in FIG. 1. The positive (negative) terminal 104 (106) includes three portions 104a (106a), 104b (106b) and 104c (106c). Portion 104a (106a) relates to a portion of the terminal received within the battery cell 102. Portion 104c (106c) relates a portion of the terminal that includes a coating of a metal “Mc”. The portion between the portions 104a (106a) and 104c (106c) is portion 104b (106b) that is not coated or coated with a metal “Mb” different from the metal in portion 104c (106c). In certain particular instances, metal Mb has a higher melting temperature than the metal Mc. Although portions 104b (106b) and 104c (106c) are depicted in FIG. 2A as substantially two equal parts, portions 104b (106b) and 104c (106c) do not have be identical in shape and may be divided by a line 204 (206) that is straight, curved, or of any other suitable shape. In certain particular instances, the portion 104b (106b) may be similarly coated as with the portion 104c (10c). In this connection, no difference is purposefully implemented between the portions 104b (106b) and 104c (106c), which can be considered one integral portion.

In certain instances, the metal as present in the coating on the positive terminal portion 104c or the negative terminal portion 106c includes tin (Sn).

The heat-sensitive coatings as present on the positive terminal portion 104c and/or the negative terminal portion 106c may be applied prior to or after the terminals 104, 106 are attached to the battery cell 102. However, for the purpose of description, following procedures will be described in the scenario that the heat-sensitive coatings are applied prior to their subsequent attachment to the battery cell 102.

As depicted in FIG. 2B, the heat-sensitive coating may be applied to the portion 104c, 106c via electroplating in a batch or continuous plating process. The balance of the terminal 104, 106 may be nickel-plated for the negative terminal 106, or unplated for the positive terminal 104. As depicted in FIG. 2C, the entirely or partially plated sheet metals are cut or blanked to the designed dimension of battery cell terminals. The entirely or partially plated battery cell terminals are then subsequently attached to the cell 102.

In certain instances, the positive and negative battery cell terminals 104, 106 are made of Sn-plated aluminum foils/sheets and Sn-plated copper foils/sheets, respectively, whereas the interconnector busbars are made of Sn-plated copper sheets.

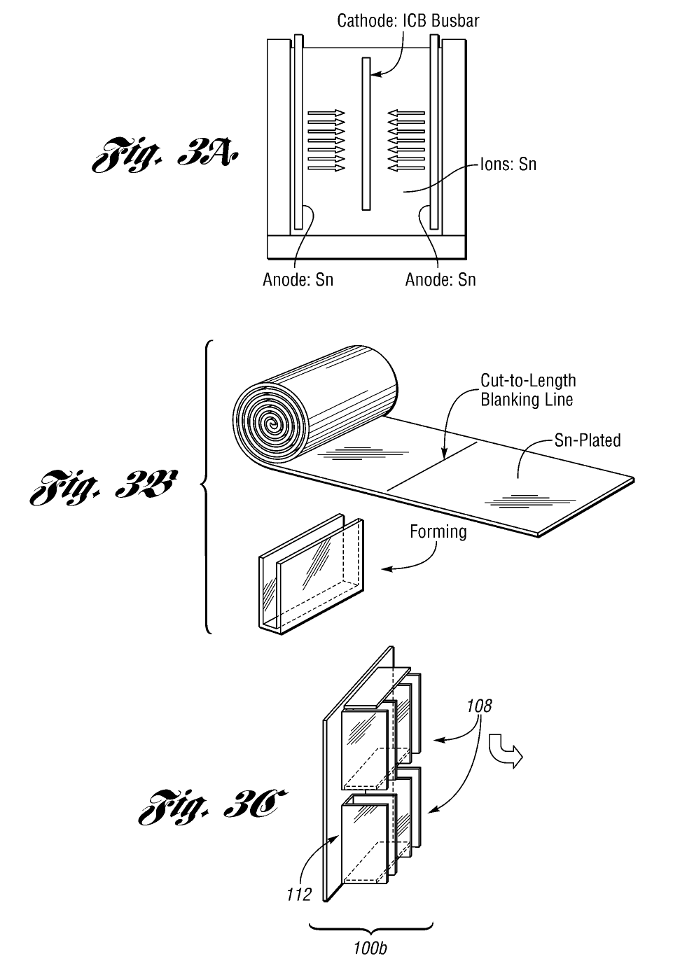

In another embodiment, and as depicted in FIG. 3A, before the interconnector busbars 108 are assembled to an interconnector board 112 in an interconnector board assembly process, the sheet metals for the interconnector busbars are plated with a coating of a metal, such as Sn, in a batch or continuous plating process to form a plated sheet metal. As depicted in FIG. 3B, the plated sheet metals are cut or blanked and formed to the designed dimension of interconnector busbars. In prog-die process, blanking is omitted, and interconnector busbars are formed and trimmed off during continuous coil feeding. As depicted in FIG. 3C, the plated interconnector busbars are joined to the interconnector board in the interconnector board assembly process using mechanical and soldering methods.

In yet another embodiment, the first coating or the second coating has a planar dimension of 90 to 110 percent, or 95 to 110 percent, of a planar dimension of the terminal substrate or the busbar substrate.

In yet another embodiment, the melting temperature of the first coating or the second coating is 100 degrees Celsius, 200 degrees Celsius, 300 degrees Celsius, 400 degrees Celsius, 500 degrees Celsius, 600 degrees Celsius, 700 degrees Celsius, 800 degrees Celsius or 900 degrees Celsius lower than a melting temperature of the terminal substrate or a melting temperature of the busbar substrate.

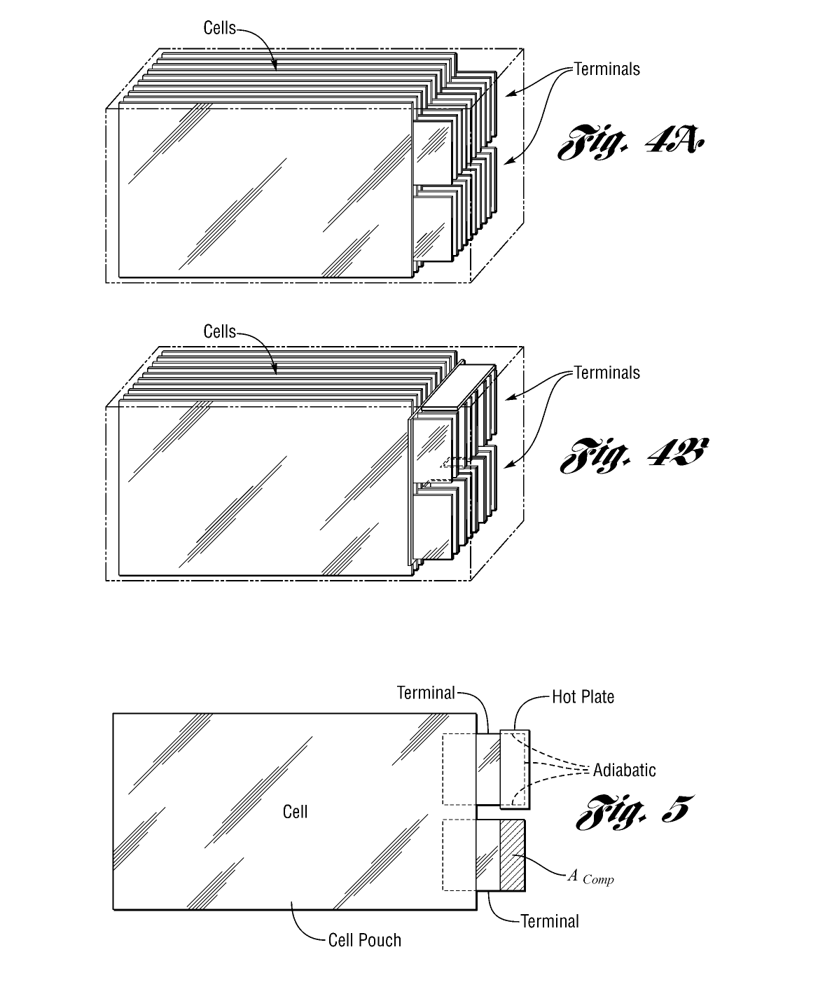

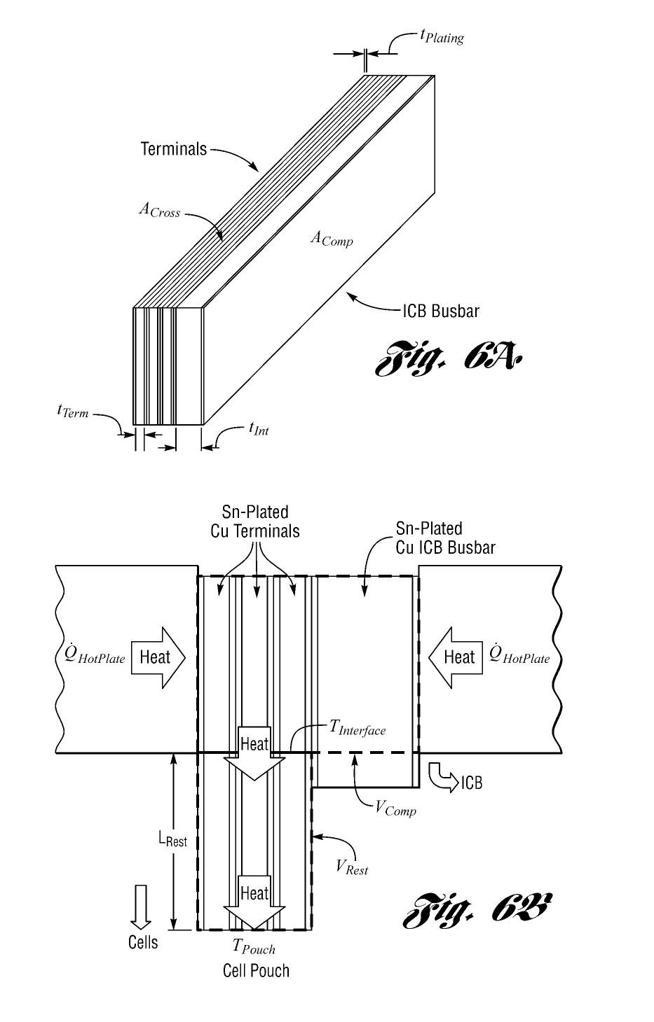

FIG. 4A illustratively depicts a number of battery cells 102 with plated battery cell terminals stacked to form a structural framework. Depending on cooling strategy, i.e., bottom, side or face cooling, cooling plates may be assembled to bottom or side, or cooling fins stacked between the battery cells. A number of the plated battery cell terminals may be grouped together. In certain designs, the plated battery cell terminals may need to be bent to different extents to better align with the interconnector busbars prior to the step of battery cell stacking, depending on the battery cell thickness, the number of battery cell terminals in each group, and whether a cooling fin is stacked between the battery cells. As illustratively depicted in FIG. 4B, each of the plated Interconnector busbars are aligned with a group of the plated battery cell terminals. The interconnector board may be joined to the framework by a mechanical method or welding, depending on interconnector board and battery module designs.

Each group of the plated battery cell terminals and one of the plated interconnector busbars are clamped and heat is provided to the heat-sensitive coating on the portions 104c, 106c of the terminals and the interconnector busbar. The heat may be provided via placing the terminals and the Interconnector busbar in a set of hot plates, or may be obtained via supplying electric current. With the heat provided, the heat-sensitive coatings on the battery cell terminals and Interconnector busbar melt and join the battery cell terminals to the Interconnector busbar. The joining process may be repeated until all groups of the battery cell terminals and remaining Interconnector busbars are joined. This completes the assembly of one battery module with the required electric interconnection.

In certain instances, the first or the second coating has a melting temperature at least 100, 200, or 300 degrees in Celsius lower than the positive terminal, the negative terminal, or the interconnector busbar such that the heat applied does not cause the terminal itself to melt. In certain particular instances, the electroplated coating has a melting temperature of 100 to 350, 150 to 300, or 200 to 250 degrees in Celsius.

In certain instances, the first or the second coating has a thickness that is 0.5% to 7.5%, 1.5% to 6.0%, or 2.5% to 5.0% of the thickness of the positive terminal or the negative terminal. In certain particular instances, the electroplated coating has a thickness of 1 to 15, 3 to 12, or 5 to 10 micrometers.

When the hot plates are employed to provide the heat, the following analysis may be used to determine certain operation parameters for carrying out the hot plate clamping of the battery cell terminals and the corresponding Interconnector busbar.

Clamping force is applied to keep the plated battery cell terminals 104, 106 and interconnector busbar 108 to be joined in good contact during heating up, melting/joining and solidification. The clamping force can be determined readily by a design of experiment for variations in battery cell terminal and/or interconnector busbar materials, and geometries of battery cell terminals, interconnector busbars and/or hot plates. In certain instances, a clamping pressure of 5 to 10 psi or a clamping force of 15 to 30 N (or about 3.5-7 lbf) may be used to minimize the thermal contact resistance at the layer-to-layer contact interfaces and to maximize the heat transfer rate, and thus to minimize the process time.

In particular, the clamping force may need to be increased if the plated interconnector busbar is not flat, or not parallel to the plated battery cell terminals in x-y plane and/or in y-z plane. A higher clamping force may be needed if the plated battery cell terminals are not flat, not aligned to the plated Interconnector busbar, and/or pre-bent to a high level of pre-strains.

However, increased clamping force increases the melting temperature of the plating metal such as Sn. Hence, the clamping process can be divided into 2 stages: (1) impact and alignment deformation, and (2) clamping. In the impact and alignment deformation stage, relatively higher forces may be used to rapidly align the plated battery cell terminals to the plated Interconnector busbar for heating up. Then, the battery cell terminals are clamped to the Interconnector busbar under a stabilized clamping force which is slightly lower than in the first stage to allow rapid melting of plating layers and to compensate the changes in the volume enclosed by the hot plates, that is, expansion during melting/joining (solid to liquid phase change), and shrinking during solidification (liquid to solid phase change).

As expressed by Equation (1), a lumped-capacitance thermal model may be used to determine the hot plate power rating.

$${V}_{Comp} {ρ}_{Comp} {c}_{pComp} \frac{d {T}_{Comp}}{d t} = 2 {A}_{Comp} {h}_{HotPlate} ( {T}_{HotPlate} - {T}_{Comp} ) - \frac{{T}_{Comp} - {T}_{Air}}{{R}_{Total}} \qquad ( 1 )$$

As referenced in Equation (1), V_{Comp} stands for volume (m³) of battery cell terminals and Interconnector busbar enclosed by hot plates; ρ_{Comp}(kg/m³) stands for average density of V_{Comp}; c_{pComp}(J/kg K) stands for average thermal capacity of V_{Comp}; T_{Comp}(K) stands for average temperature of V_{Comp}; t stands for time in s; A_{Comp} stands for contact area (m²) between a hot plate and a battery cell terminal or Interconnector busbar; h_{HotPlate} stands for heat transfer coefficient (W/m²K) between a hot plate and a battery cell terminal or Interconnector busbar on the contact area; T_{HotPlate} stands for surface temperature (K) of a hot plate at the contact interface; T_{Air} stands for room temperature (K); and R_{Total} stands for total thermal resistance (K/W) from battery cell terminal through cell to cell surfaces.

As a first-order approximation, the model of Equation (1) may be simplified to Equation (2) shown below.

$${V}_{Comp} {ρ}_{Comp} {c}_{pComp} \frac{d {T}_{Comp}}{d t} \approx 2 {\dot{Q}}_{HotPlate} \qquad ( 2 )$$

As referenced in Equation (2), \dot{Q}_{HotPlate} stands for hot plate power (W).

Equation (3) may be obtained by integrating Equation (2) with initial value T_{Comp}=T_{Air} at t=0.

$${T}_{Comp} \approx \frac{2 {\dot{Q}}_{HotPlate} t}{{V}_{Comp} {ρ}_{Comp} {c}_{pComp}} + {T}_{Air} \qquad ( 3 )$$

The composite properties may be determined using the following Equations (4) to (9).

$$\begin{matrix}{V}_{Int} = {A}_{Comp} {t}_{Int} \\ {V}_{Term} = {A}_{Comp} {t}_{Term} \\ {V}_{Plating} = {A}_{Comp} {t}_{Plating} & ( 7 ) \\ {m}_{Int} = {V}_{Int} {ρ}_{Int} \\ {m}_{Term} = {V}_{Term} {ρ}_{Term} \\ {m}_{Plating} = {V}_{Plating} {ρ}_{Plating} & ( 8 ) \\ {m}_{Comp} = {m}_{Int} + 3 {m}_{Term} + 8 {m}_{Plating} & ( 9 )\end{matrix}$$

As referenced in Equations (4) to (9), t_{Int}, t_{Term}, t_{Plating} stands for thickness (m) of Interconnector busbar, battery cell terminal, and electroplated coating, respectively; V_{Int}, V_{Term}, V_{Platin} stands for volume (m³) of Interconnector busbar, battery cell terminal, and the electroplated coating, respectively; ρ_{Int}, ρ_{Term}, ρ_{Plating} stands for density (kg/m³) of a

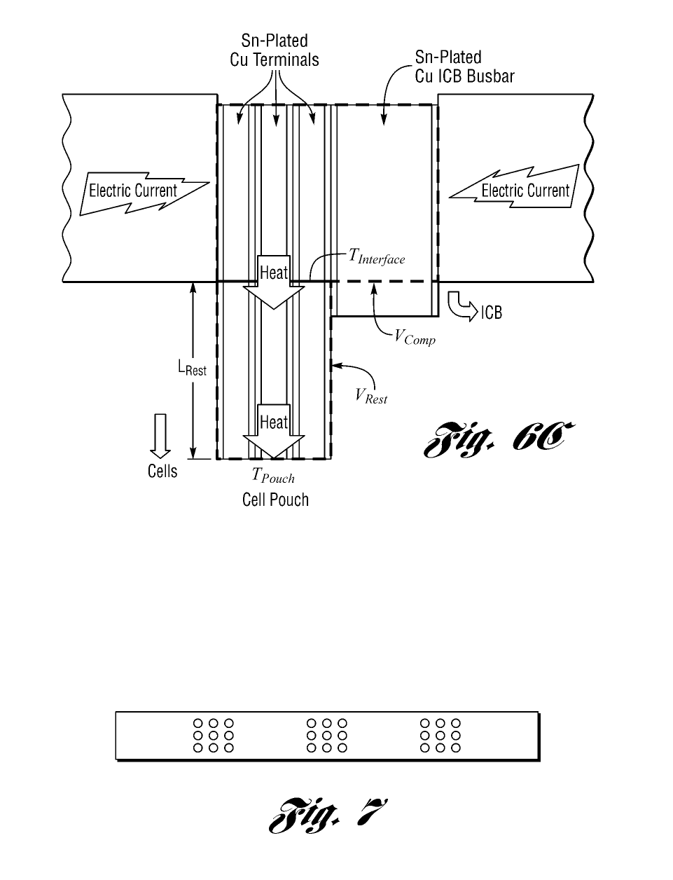

Interconnector busbar, battery cell terminal, and the electroplated coating, respectively; C_{pInt}, C_{pTerm}, C_{pPlating} stands for thermal capacity (J/kg·K) of Interconnector busbar, battery cell terminal, and the electroplated coating, respectively; m_{Int}, m_{Term}, m_{Plating} stands for mass (kg) of Interconnector busbar, battery cell terminal, and the electroplated coating, respectively; and m_{Comp} stands for mass (kg) of battery cell terminals and Interconnector busbar enclosed by hot plates. Note that numerals 3 and 8 referenced in Equations (4) to (9) represent a composite having one Interconnector busbar, three terminals and eight electroplated coatings, as illustratively depicted in FIG. 6. These numerals may vary based on the total number of terminals grouped within a single Interconnector busbar and how many coatings are used.

The time, t_{Tm}, needed to raise the temperature of the plated battery cell terminals and Interconnector busbar enclosed by the hot plates to the melting temperature, Tₘ, of the plating may be determined using following Equation (10).

t_{T}_{ₘ}≈(Tₘ−T_{Air})(V_{Comp}ρ_{Comp}C_{pComp})/(2\dot{Q}_{HotPlate)} (10)

The time, t_{L}, needed to completely melt all the plating layers on the plated battery cell terminals and Interconnector busbar enclosed by hot plates may be determined using the following Equation (11)

t_{L}=ΔHₘnm_{Plating}/(2\dot{Q}_{HotPlate)} (11)

Wherein ΔHₘ stands for latent heat of fusion (kJ/kg) of the electroplated coating and n stands for number of the coating layers.

A heat transfer model expressed in Equation (12) may be used to determine the maximum temperature of battery cell terminals at cell edge 110.

$${V}_{Rest} {ρ}_{Rest} {c}_{pRest} \frac{d {T}_{Pouch}}{d t} \approx {K}_{Rest} {A}_{Cross} \frac{{T}_{Interface} - {T}_{Pouch}}{{L}_{Boundary}} \qquad ( 12 )$$

As referenced in Equation (12), V_{Rest} stands for volume (m³) of battery cell terminals & their electroplated coating layers outside the enclosed volume; ρ_{Rest} stands for density (kg/m³) of battery cell terminals & their electroplated coating layers outside the enclosed volume; c_{pRest} stands for thermal capacity (J/kg K) of battery cell terminals & their Sn plating layers outside the enclosed volume; T_{Pouch} stands for temperature (K) of battery cell terminals at cell pouch edge, same as the average temperature of V_{Rest}; K_{Rest} stands for thermal conductivity (W/m·K) of battery cell terminals & their electroplated coating layers; A_{Cross} stands for cross-section area (m²) of battery cell terminals & their electroplated coating layers; T_{Interface} stands for temperature (K) of battery cell terminals at the boundary of the enclosed volume, same as T_{Comp}; and L_{Boundary} stands for thickness (m) of the boundary layer between the enclosed and outside volumes.

Owing to the excellent thermal conductivities of the battery cell terminals, the temperature within the battery cell terminals in the volume enclosed by the hot plates is believed to be uniform, T_{Interface}=T_{Comp}. Similarly, the temperature within the battery cell terminals outside the enclosed volume is approximately uniform, T_{Pouch}, except in the boundary layer between the two volumes. The boundary layer may be very thin, for instance, at a thickness of 1 mm, which is at the interface where the two volumes overlap.

Equation (12a) is obtained when T_{Interface} in Equation (12) is substituted by T_{Comp} of Equation (3).

$${V}_{Rest} {ρ}_{Rest} {c}_{pRest} \frac{d {T}_{Pouch}}{d t} \approx \frac{{K}_{Rest} {A}_{Cross}}{{L}_{Boundary}} ( \frac{2 {\dot{Q}}_{HotPlate} t}{{V}_{Comp} {ρ}_{Comp} {c}_{pComp}} + {T}_{Air} - {T}_{Pouch} ) \qquad ( 12 a )$$

Equation (13) can be obtained from Equation (12).

$${C}_{3} = {K}_{Rest} {A}_{Cross} / ( {L}_{Boundary} {C}_{1} ) \\ {C}_{1} = {V}_{Rest} {ρ}_{Rest} {c}_{pRest} \\ {C}_{2} = {V}_{Comp} {ρ}_{Comp} {c}_{pComp} \\ {C}_{4} = 2 {C}_{3} {\dot{Q}}_{HotPlate} / {C}_{2} \\ {C}_{5} = {C}_{3} {T}_{Air} \qquad ( 13 )$$

Equation (12a) may be reduced to what is expressed in Equation (12b).

$$\frac{d {T}_{Pouch}}{d t} \approx - {C}_{3} {T}_{Pouch} + {C}_{4} t + {C}_{5} \qquad ( 12 b )$$

Equation (14) represents the initial condition.

(14)

Equation (15) represents the temperature of battery cell terminals at cell edge 110 by solving the initial value of Equation (14).

$${T}_{Pouch} = \frac{{C}_{5}}{{C}_{3}} - \frac{{C}_{4}}{{C}_{3}^{2}} + \frac{{C}_{4}}{{C}_{3}} t + exp ( - {C}_{3} t ) [ {T}_{Air} - \frac{{C}_{5}}{{C}_{3}} + \frac{{C}_{4}}{{C}_{3}^{2}} ] \qquad ( 15 )$$

When the heat is provided by electrode plates, and electric current is applied to the plated battery cell terminals and plated Interconnector busbar via the electrode plates, heat Q (J) is generated depending on three basic factors as expressed in the following Equation (16).

Q=I²Rt (16)

Where I (A) is the electric current passing through the plated battery cell terminals and plated Interconnector busbar; R (Ω) is the electric resistance of the sheet/foil metal, the platings and the contact interfaces; and t (s) is the time of the electric current flow.

The heat generation may be linearly proportional to the time during which the electric current is applied, as shown in Equation (16). A minimum electric current and a minimum time are required to generate sufficient heat for joining the sheet/foil metals via melting/joining of plating layers on them, and also for compensating the heat losses due to heat transfer. If the electric current is too low, simply increasing the time alone cannot produce a joint. If the electric current is adequate, the size of the joint increases with increasing time until it reaches the size of the electrode protrusion contact area. If the time is increased further, expulsion may occur or the Electrode Plates may adhere to the sheet/foil metals. Hence, DOE should be conducted to optimize the electric current and time for individual joining applications.

The electric current is a factor as it may influence the heat generation, as shown in Equation (16). The actual size of the joints increases rapidly with increasing electric current. However, too high electric current results in expulsion and electrode plate deterioration. The typical types of the electric current applied in the joining include the single phase alternating current (AC) that is the most used in production, the three phase direct current (DC), the condensator discharge (CD), and the relatively new mid-frequency inverter DC. In operations, the root mean square (RMS) values of the electric current should be used for process parameter settings and controls.

The electrode plate power can be calculated according to Equation (17) which is obtained by rearranging Equation (16).

\dot{Q}=Q/t=I²R (17)

When using electrode plates with protrusions of 1 mm diameter in a matrix as shown in FIG. 9, the electric current passing through the plated battery cell terminals and plated Interconnector busbar via each protrusion can be determined via the following Equation (18).

I=√\dot{Q}/R (18)

In certain instances, structural protrusions may be formed on a contacting surface of the electrode plates to enhance electric flow. As illustratively depicted in FIG. 7, the protrusions may take any geometrical shape, and can be spaced apart from each other with any suitable spacing distance.

Clamping force is to keep the plated battery cell terminals and Interconnector busbar to be joined in intimate contact during heating up, melting/joining and solidification. The clamping force delivered by electrode plates may be determined according to one or more of the same principles and methodologies as with the hot plates procedure described herein. By way of example, a clamping force of 15 to 30 N (3.5 to 7 lbf) is used to enable the application of the electric current, to promote rapid filling of surface roughness valleys by molten plating material such as molten Sn, and to minimize the formation of pores during solidification of the molten plating layers. The clamping force may be increased if the plated Interconnector busbar is not flat, or not parallel to the plated battery cell terminals in x-y plane and/or in y-z plane. A higher clamping force may be used if the plated battery cell terminals are not flat, not aligned to the plated Interconnector busbar, and/or pre-bent to a high level of pre-strains. However, increasing clamping force increases the melting temperature of the plating material such as Sn. Hence, the clamping force may be adjusted using a DOE which includes certain key process input variables (KPIVs), their interactions and their variations, notably battery cell terminal and/or Interconnector busbar materials, geometries and pre-strains of battery cell terminals, Interconnector busbars and/or electrode plates.

Selection of material and design of surface finish and hardness for the electrode plates may be carried out according to one or more of the same strategies and principles set forth herein in relation to the hot plates procedure. One or more of the same requirements may also apply to the electrode plates procedure in terms of functionality, durability and compatibility to the materials and process conditions. Accordingly, Molybdenum or Tungsten can be machined and polished to form the Electrode Plates. In certain instances, the surface finish of the electrode plates may be better than the plated battery cell terminals and/or the plated Interconnector busbar, with a value of being about 0.3-0.5 micrometer Ra. Generally speaking, the smoother and less stickier the surface, the less maintenance and more uniformity across the contact area. In certain particular instances, the electrode plate materials have a hardness of greater than 75 HRc. In this regard, molybdenum and tungsten, each having a Vickers hardness of 1530 and 3430, respectively, may be the material of choice.

Without wanting to be limited to any particular theory, the present invention, in one or more embodiments, is believed to have one or more of the following advantages. Firstly, the hot plates or electrode plates may be made relatively thin, for instance, at a thickness of about 5 mm, which enables the plates to readily fit into the confined space between the Interconnector busbars in a compact design, and therefore simplifying automation engineering for the joining process and eliminating the tooling constraints as may be encountered in most other joining techniques. Secondly, the low-melting-temperature of Sn plating minimizes the energy input and clamping force, and hence minimizes the heat impact to battery cells and ICB, in contrast to many other joining techniques that rely on a high heat or high energy input such as laser welding, resistance spot welding, brazing and ultrasonic welding. Thirdly, reduced energy requirement facilitates tool life extension and thus reduction of total cycle time due to reduced down time for tool replacement. Fourthly, the low-melting-temperature Sn plating on the same or dissimilar sheet/foil metals of various thicknesses enables fast melting/joining via the Sn layers, minimizing formation of brittle intermetallics often related to many other joining techniques. Fifthly, for a given power rating with the use of hot plates, the joining time for 2-cell-terminals to 3-cell-terminals may be reduced to be only 15-33% of that is required in conventional techniques such as ultrasonic welding. Sixth, the soft and low-melting-temperature Sn plating on multilayer of sheet/foil metals also eliminates the need for high mechanical energy to deform (cold-form) the sheet/foil metals as may be required in many other conventional techniques such as riveting, clinching, or crimping. Seventhly, for a given energy input, the Sn—Sn metallurgical bonds among battery cell terminals and between battery cell terminals and Interconnector busbars exhibit lower interfacial resistance and thus lower power loss across the joints and less heat buildup during service, as compared to certain conventional techniques such as ultrasonic welding, laser welding, resistance spot welding, fastening, riveting, clinching or crimping. Lastly, the Sn—Sn metallurgical bonds among battery cell terminals and between battery cell terminals and Interconnector busbars are more reliable than certain convention techniques such as many mechanical joining methods, in particular under fretting conditions typical of vehicle usage.

In certain instances, the hot plates and the electrode plates may be identical in one or more of the following features: geometry, dimension in length, width or thickness, material, surface finish, and hardness.

In certain instances, the hot plates and/or the electrode plates have a planar area greater than the coated portions 104c of the battery cell terminals and/or the coated portion 106c of the Interconnector busbar. In certain particular instances, the hot plates and/or the electrode plates have a planar area that is, by 0.1 mm to 5 mm greater in each of the three pseudo-adiabatic dimensions, than the coated portions 104c and/or 106c.

In certain instances, the hot plates and/or the electrode plates are spaced apart from the battery cells, the battery cell terminals, and/or the Interconnector busbars.

### EXAMPLES

### Example 1

In this example, a group of Sn-plated battery cell terminals and one Sn-plated Interconnector busbars are clamped by two hot plates, with heat applied. The electroplated Sn coating melt and join the battery cell terminals with the Interconnector busbar. Table 1 illustratively lists certain mechanical, thermal, metallurgical and electrical properties important to joining and joints.

TABLE 1
Properties of Battery Cell Terminals & Interconnector busbars

| | Battery Cell Terminals | | | Interconnector busbar | |
|---|---|---|---|---|---|
| | Al (+) * | Cu (−) * | Sn (+/−) | Cu | Sn |
| Thickness (μm) | 200 | 200 | 5-10 | 800 | 5-10 |
| TS (MPa) | 77 | 240 | 19 ** | 245 | 19 ** |
| TE (%) | 18 | 46 | 43 ** | 10 | 43 ** |
| Hardness (HV0.1) *** | 15 HV | <70 HV | 30 | 90 HV | 30 |
| Density - Solid (kg/m³) | 2700 | 8950 | 7298(β) | 8890 | 7298(β) |
| Thermal Conductivity - Solid (W/m · K) | 238 | 397 | 62.2 | 388 | 62.2 |
| Thermal Capacity - Solid (J/kg · K) | 917 | 386 | 226 | 385 | 226 |
| Melting Temperature, Tₘ (° C.) | 660 | 1083 | 232 | 1083 | 232 |
| Latent Heat of Fusion (kJ/kg) | 388 | 205 | 59.61 | 205 | 59.61 |
| Density - Liquid at Tₘ (kg/m³) | 2385 | 8000 | 7000 | 8000 | 7000 |
| Thermal Conductivity - Liquid (W/m · K) | 100 | 165 | 31.4 | 165 | 31.4 |
| Thermal Capacity - Liquid (J/kg · K) | 1178 | 490 | 242 | 490 | 242 |
| Coefficient of Thermal Expansion (10⁻⁶ K⁻¹) | 25.5 | 17.7 | 23 | 17.7 | 23 |
| Surface Tension - Liquid at Tₘ (N/m) | 0.914 | 1.285 | 0.544 | 1.285 | 0.544 |
| Self-Diffusivity in Liquid at Tₘ | 4.87 | 3.97 | 2.31 | 3.97 | 2.31 |
| (10⁻⁹ m²/s) | | | | | |
| Effective Molecular Diameter - Liquid at Tₘ | 2.66 | 2.37 | 3.05 | 2.37 | 3.05 |
| (10⁻¹⁰ m) | | | | | |
| Viscosity - Liquid at Tₘ (mN · s/m²) | 1.250 | 4.502 | 4.459 | 4.502 | 4.459 |
| Electrical Conductivity (% IACS) **** | 65 | 101 | 15.6 | 100 | 15.6 |
| Electrical Conductivity (MegaS/m) | 37.67 | 58.69 | 9.05 | 58.11 | 9.05 |
| Electrical Resistivity (μΩ · cm) | 2.65 | 1.71 | 12.1 | 1.72 | 12.1 |

* Mechanical properties are measured, and the rest of properties are from theoretical calculations or publications.
** Properties in freeform.
*** Hardness data is for comparison only. The actual hardness is dependent on the heat treatment & should be specified based on application.
**** 172.41/Resistivity = % IACS; 100% IACS = 58 MegaS/m.

In certain instances, hot plates may be slightly larger than the battery cell terminals and Interconnector busbar to produce as large as possible contact area in order to reduce the interfacial resistance. In this example, the length and width of the contact area is 45 mm and 5 mm, respectively. The length, width and thickness of the hot plate are 50 mm, 6 mm, and 5 mm, respectively. Design parameters, physical properties and calculated parameters are summarized in Table 2.

TABLE 2
Summary of Design Parameters, Physical
Properties and Calculated Parameters

| | Inter- | Cell | Plating | Com- |
|---|---|---|---|---|
| | connector | Terminal | | posite |
| | A_{Comp} | | | |
| Contact Area (m²) | 0.005 × 0.045 = 0.000225 | | | |
| Thickness (cm) | t_{Int} | t_{Term} | t_{Plating} | t_{Comp} |
| 2 Cell Terminals | 0.8 | 0.2 | 0.01 | 1.26 |
| 3 Cell Terminals | | | | 1.48 |
| Volume (cm³) | V_{Int} | V_{Term} | V_{Plating} | V_{Comp} |
| 2 Cell Terminals | 180 | 45 | 2 | 280 |
| 3 Cell Terminals | | | | 330 |
| Density - Solid | | | | |
| (kg/m³) | ρ_{Int} | ρ_{Term} | ρ_{Plating} | ρ_{Comp} |
| 2 Cell Terminals | 8890 | 8950 | 7298 | 8833 |
| 3 Cell Terminals | | | | 8828 |
| Mass (g) | m_{Int} | m_{Term} | m_{Plating} | m_{Comp} |
| 2 Cell Terminals | 1.6 | 0.4 | 0.02 | 2.5 |
| 3 Cell Terminals | | | | 2.9 |
| Thermal Capacity | | | | |
| (J/kg · K) | c_{pInt} | c_{pTerm} | c_{pPlating} | c_{pComp} |
| 2 Cell Terminals | 385 | 386 | 226 | 379 |
| 3 Cell Terminals | | | | 378 |

For Sn-plating, the calculated time to melting temperature and time to complete melting as well as total time for complete melting/joining are summarized in Table 4 for various hot plate power ratings, respectively.

TABLE 3
Summary of Design Parameters, Material
Properties and Calculated Parameters

| Hot Plate Power, \dot{Q}_{HotPlate} (W) | 1000 | 2000 | 3000 | 4000 |
|---|---|---|---|---|
| Room Temperature, T_{Air}(° C.) (K) | 23° C. = 296 K | | | |
| V_{Comp}ρ_{Comp}c_{pComp}(J/K) | | | | |
| 2 Cell Terminals | 0.949 | | | |
| 3 Cell Terminals | 1.112 | | | |
| Melting Temperature, Tₘ (° C.) (K) | 232° C. = 505 K | | | |
| (Tₘ − T_{Air})(V_{comp}ρ_{Comp}c_{pComp})/2 (J) | | | | |
| 2 Cell Terminals | 99.198 | | | |
| 3 Cell Terminals | 116.220 | | | |
| Time to Melting Temperature, t_{Tm} (s) | | | | |
| 2 Cell Terminals | 0.099 | 0.050 | 0.033 | 0.025 |
| 3 Cell Terminals | 0.116 | 0.058 | 0.039 | 0.029 |
| Latent Heat of Fusion, ΔHₘ (kJ/kg) | 59.61 | | | |
| Time to Complete Melting, t_{L} (s) | | | | |
| 2 Cell Terminals = 6 Plating Layers | 0.003 | 0.001 | 0.001 | 0.001 |
| 3 Cell Terminals = 8 Plating Layers | 0.004 | 0.002 | 0.001 | 0.001 |
| Total Time for Complete Melting/ | | | | |
| Joining, t_{T} = t_{Tm} + t_{L} (s) | | | | |
| 2 Cell Terminals = 6 Plating Layers | 0.102 | 0.051 | 0.034 | 0.026 |
| 3 Cell Terminals = 8 Plating Layers | 0.120 | 0.060 | 0.040 | 0.030 |

Determining Hot Plate Holding Time

Maximum component temperature and hot plate holding time may be determined based on one or more of the limiting temperatures and allowed times of the pouch insulation film, separator between positive or negative electrodes, electrolyte and active electrode coatings of the battery cells, and the ICB. Non-limiting examples of the limiting temperatures are summarized in Table 4 below.

TABLE 4
Limiting Temperatures of Cell Pouch Insulation
Film, Separator, Electrolyte and Active Electrode
Coatings of Battery Cells, and ICB

| | Temperature |
|---|---|
| Materials | Limits |
| Cell Pouch Insulation Film | 158° C. |
| Homo PP + Co-polymer PP + PE (CPP) Film Sealant Layer | |
| Modified polypropylene (PP) Extrusion Coating | |
| Oriented Polyamide (ONy) Film | |
| Polyethylene Terephthalate (PET) Base Film | |
| Polyethylene-Polypropylene (PE-PP) Separator | 123° C. |
| Lithium Salt (LiPF6 + additives) Electrolyte | 236° C. |
| Active Electrode Coatings & SBR or PVDF, CB, SFG-6 | 140° C. |
| Binder/Solvent/Additives | |
| Anode: Graphite or Graphene | |
| Cathode: LiNixMnyCozO₂, LiNiCoAlO₂, LiMn₂O₄, | |
| LiCoO₂, or C—LiFePO₄ | |
| ICB | 260° C. |

As shown in Table 4, the separator seems to have the lowest limiting temperature. However, each battery cell terminal transfers heat to tens of battery cell tabs within a pouch which in-turn transfer heat to tens of Separators between Cathodes and Anodes. The mass of the Electrodes and Separators is orders of magnitude larger than that of the battery cell terminal which they are joined to via the battery cell tabs. In addition, the Electrodes exhibit excellent thermal conductivities. Hence, they serve as a giant heat sink to dissipate heat from the battery cell terminal so rapidly that the Separators and Active Electrode Coatings remain intact by the heat. Thus, the Cell Pouch Insulation Film turns out to be the weakest link and the most susceptible gate in the thermal chain since it is closest to the battery cell terminals and the very first to ‘take the heat’. Accordingly, 158° C. for 10 seconds at cell pouch edge would set the limit of the heat flux from hot plates through battery cell terminals to the battery cells.

The hot plate holding time may be equal to or slightly longer than the total time for complete melting/joining for the respective hot plate power ratings listed in Table 3, and may be shorter than 10 seconds to prevent thermal damage to the battery cells. Accordingly, for the hot plate power ratings of 1000 to 4000 W, the hot plate holding times may be determined according to Equations (10) to (11), and are summarized in Table 5 below.

TABLE 5
Hot plate holding times at various hot plate power ratings

| | Hot Plate Power, \dot{Q}_{HotPlate} (W) | | | |
|---|---|---|---|---|
| Hot Plate Holding Time (ms) | 1000 | 2000 | 3000 | 4000 |
| 2 Cell Terminals = 6 Plating Layers | 102 | 51 | 34 | 26 |
| 3 Cell Terminals = 8 Plating Layers | 120 | 60 | 40 | 30 |

For these hot plate power ratings and corresponding hot plate holding times, maximum temperatures of battery cell terminals at cell pouch edge, T_{Pouch}, are determined according to Equation (15) and are summarized in Table 6 below.

TABLE 6
Temperatures of Battery Cell Terminals at Cell
Pouch Edge for Various Hot Plate Power Ratings

| Cross-Section/Rest Areas | | | | |
|---|---|---|---|---|
| (cm²) & Rest Lengths (cm) | A_{Cross} | A_{Rest} | L_{Rest} | L_{Boundary} |
| 2 Cell Terminals | 0.20 | 8.4 | 1.9 | 0.1 |
| 3 Cell Terminals | 0.30 | | | |
| Thickness (cm)/Volume (cm³) | t_{Rest} | V_{Term} | V_{Plating} | V_{Rest} |
| 2 Cell Terminals | 0.044 | 0.2 | 0.008 | 0.4 |
| 3 Cell Terminals | 0.066 | | | 0.6 |
| Density(kg/m³)/Mass (kg) | ρ_{Rest} | m_{Term} | m_{Plating} | m_{Rest} |
| 2 Cell Terminals | 8800 | 0.00150 | 0.00006 | 0.00324 |
| 3 Cell Terminals | 8800 | | | 0.00486 |
| Thermal Capacity (J/kg · K) | | | | |
| & Conductivity (W/m · K) | c_{pRest} | K_{Term} | K_{Plating} | K_{Rest} |
| 2 Cell Terminals | 374 | 397 | 62 | 367 |
| 3 Cell Terminals | 374 | | | 367 |
| C₁, C₂, C₃, C₅ | C₁ | C₂ | C₃ | C₅ |
| 2 Cell Terminals | 1.212 | 0.949 | 5.989 | 1773 |
| 3 Cell Terminals | 1.818 | 1.112 | 5.989 | 1773 |
| Hot Plate Power, \dot{Q}_{HotPlate} (W) | 1000 | 2000 | 3000 | 4000 |
| C₄ | | | | |
| 2 Cell Terminals | 12618 | 25237 | 37855 | 50474 |
| 3 Cell Terminals | 10770 | 21541 | 32311 | 43082 |
| T_{Pouch}(K) | | | | |
| 2 Cell Terminals | 350 | 326 | 317 | 312 |
| 3 Cell Terminals | 358 | 331 | 320 | 314 |
| T_{Pouch}(° C.) | | | | |
| 2 Cell Terminals | 77 | 53 | 44 | 39 |
| 3 Cell Terminals | 85 | 58 | 47 | 41 |

As can be seen from Table 6, these temperatures are much lower than the maximum allowed temperature at the cell pouch edge and for much shorter time duration than the limiting time, 158° C. for 10 seconds at cell pouch edge as posed by the constraints from Cell Pouch Insulation Film. This design will not cause thermal damage to the separators since the temperature and time are much lower/shorter than the limiting conditions, 123° C. for 10 seconds at Separators. Hence, the hot plate holding times shown in Table 6 are safe operation times within which the battery cells will not be thermally damaged while the Sn-plated battery cell terminals are joined to the Sn-plated Interconnector busbar. It is also noted that the operation temperatures and times in the current design are lower and much shorter than those in ultrasonic welding due to the lower energy inputs and the lower melting temperature of the Sn-plating on the battery cell terminals and Interconnector busbars.

### Example 2

In this example, each group of the Sn-plated battery cell terminals and one of the Sn-plated Interconnector busbars are clamped by two Electrode Plates while electric current is applied to the Sn-plated battery cell terminals and Interconnector busbar. The Sn plating layers on the battery cell terminals and Interconnector busbar melt and join the battery cell terminals to the Interconnector busbar, as depicted in FIG. 8.

In this example, the electrode plate length, width and thickness are 45 mm, 5 mm, and 5 mm, respectively. For flat electrode plates, the contact area is 45mm×5mm on the surfaces of the outermost Sn-plated battery cell terminal and Sn-plated Interconnector busbar, respectively. For electrode plates with protrusions of 1 mm diameter in a matrix as shown in FIG. 9, the contact area of each protrusion is 0.785 mm² on the surfaces of the outermost Sn-plated battery cell terminal and Sn-plated Interconnector busbar, respectively.

When using electrode plates with protrusions of 1 mm diameter in a matrix as shown in FIG. 9, the electric current passing through the plated battery cell terminals and plated Interconnector busbar via each protrusion can be determined via Equation (18) and are summarized in Table 8. the cross-section area which the electric current passes through isA_{Electrode}=0.785 mm², the electric resistivity values of the sheet/foil metals and Sn-plating are from Table 1, and the electric resistance values are calculated based on the electric resistivity, the thickness of the sheet/foil metals and Sn-plating and the cross-section area A_{Electrode}. The actual electric current required is smaller than those listed in Table 8 because the electric resistance of the contact interfaces is not included in the present calculations. The electric resistance of the contact interfaces needs to be determined by experimental measurements of the actual set up. Nevertheless, for these electric current levels, the joining process can be completed within a few milli-seconds. The same method as used in the Application Example 1 above can be used for calculating the total time for complete joining.

TABLE 7
Electric Current thru Battery Cell Terminals & Interconnector
busbar for Various Electrode Plate Power Ratings

| | ICB | Terminal | Plating | Composite |
|---|---|---|---|---|
| Thickness (m) | t_{Int} | t_{Term} | t_{Plating} | t_{Comp} |
| 2 Cell Terminals | 8E−04 | 2E−04 | 0.1E−04 | 12.6E−04 |
| 3 Cell Terminals | | | | 14.8E−04 |
| Electric Resistivity, ρ | 1.7 | 1.7 | 12.1 | |
| (μΩ · cm) | | | | |
| Electric Resistance, | 18E−06 | 4.4E−06 | 1.5E−06 | |
| R = ρ*t_{X}/A_{Electrode} (Ω) | | | | |
| 2 Cell Terminals | | | | 35E−06 |
| 3 Cell Terminals | | | | 43E−06 |
| Electrode Plate Power, | 1000 | 2000 | 3000 | 4000 |
| \dot{Q} (W) | | | | |
| Electric Current, I (kA) | | | | |
| 2 Cell Terminals | 5 | 8 | 9 | 11 |
| 3 Cell Terminals | 5 | 7 | 8 | 10 |

Some of the symbols and equations referenced herein may be specified according to Table 8.

TABLE 8
non-limiting definitions for certain symbols and equations

| Symbols | Definitions | Units |
|---|---|---|
| A_{Comp} | Contact area between a hot plate and a | m² |
| | coated battery cell terminal or a coated | |
| | interconnector busbar, where heat is applied | |
| A_{Cross} | Cross-section area of battery cell terminals | m² |
| A_{Electrode} | Contact area between an electrode plate | m² |
| | and a coated battery cell terminal or a | |
| | coated interconnector busbar, which electric | |
| | current passes through | |
| A_{Rest} | Surface area of a battery cell terminal | m² |
| | outside the enclosed volume | |
| c_{pComp} | Average thermal capacity of V_{Comp} | J/kg · K |
| c_{pInt}, | Thermal capacity of interconnector busbar | J/kg · K |
| c_{pTerm}, | substrate material, battery cell terminal | |
| c_{pPlating} | substrate material, and coating material, | |
| | respectively | |
| c_{pRest} | Thermal capacity of battery cell terminals | J/kg · K |
| | outside the enclosed volume | |
| C₁, C₂, C₃, | Time-independent constants | |
| C₄, C₅ | | |
| h_{HotPlate} | Heat transfer coefficient between a hot | W/m² · K |
| | plate and a coated battery cell terminal | |
| | or a coated interconnector busbar over | |
| | the contact area A_{Comp} | |
| ΔHₘ | Latent heat of fusion of coating material | kJ/kg |
| I | Electric current passing through coated | A |
| | battery cell terminals and coated inter- | |
| | connector busbar | |
| K_{Plating} | Thermal conductivity of coating material | W/m · K |
| K_{Rest} | Thermal conductivity of battery cell | W/m · K |
| | terminals in V_{Rest} | |
| K_{Term} | Thermal conductivity of battery cell | W/m · K |
| | terminal substrate material | |
| L_{Boundary} | Thickness of boundary layer between the | m |
| | enclosed and outside volumes | |
| L_{Rest} | Length of battery cell terminals outside | m |
| | the enclosed volume | |
| m_{Comp} | Mass of coated battery cell terminals and | kg |
| | coated interconnector busbar enclosed by | |
| | hot plates | |
| m_{Int}, | Mass of an uncoated interconnector busbar, | kg |
| m_{Term}, | an uncoated battery cell terminal, and a | |
| m_{Plating} | coating, respectively, in a specified volume | |
| m_{Rest} | Mass of battery cell terminals outside the | kg |
| | enclosed volume | |
| n | Number of coating layers in terminal-busbar | |
| | composite | |
| Q | Heat generated when electric current is | J |
| | applied to coated battery cell terminals | |
| | and coated interconnector busbar via | |
| | electrode plates | |
| \dot{Q} | Electrode plate power | W |
| \dot{Q}_{HotPlate} | Hot plate power | W |

While the best mode for carrying out the invention has been described in detail, those familiar with the art to which this invention relates will recognize various alternative designs and embodiments for practicing the invention as defined by the following claims.

1. A battery cell module comprising:
a battery cell terminal including a terminal substrate;
an interconnector busbar including a busbar substrate; and
a coating disposed between and contacting at least one of the terminal and busbar substrates, the coating including a metal and having a melting temperature smaller than a melting temperature of the terminal or busbar substrate.

2. The battery cell module of claim 1, wherein the coating includes a first coating of a metal M1 and second coating of a metal M2, the first coating contacting the terminal substrate, and the second coating contacting the busbar substrate.

3. The battery cell module of claim 2, wherein the terminal substrate has a melting temperature greater than a melting temperature of the first coating, the battery cell terminal being connected to the interconnector busbar via one or more M1-M2 metallurgical bonds.

4. The battery cell module of claim 2, wherein the busbar substrate has a melting temperature greater than a melting temperature of the second coating, the battery cell terminal being connected to the interconnector busbar via one or more M1-M2 metallurgical bonds.

5. The battery cell module of claim 2, wherein the metal M1 and the metal M2 are the same.

6. The battery cell module of claim 1, further comprising a another battery cell terminal connected to the battery cell terminal such that the battery cell terminal is positioned between the other battery cell terminal and the interconnector busbar.

7. The battery cell module of claim 1, wherein the coating has a planar dimension that is 90 to 110 percent of a planar dimension of the terminal substrate or the busbar substrate.

8. A method of forming a battery cell module, comprising:
disposing a coating between a terminal substrate of a battery cell terminal and a busbar substrate of an interconnector busbar, the coating having a melting temperature lower than a melting temperature of the terminal substrate or the busbar substrate; and
subjecting the coating to heat to join the terminal substrate and the busbar substrate.

9. The method of claim 8, wherein the step of disposing includes applying a first coating of a metal M1 to the terminal substrate and a second coating of a metal M2 to the busbar substrate, and the terminal substrate are connected to the busbar substrate via one or more M1-M2 metallurgic bonds formed upon heat between the first and second coatings.

10. The method of claim 8, wherein the subjecting step includes placing the battery cell terminal and the interconnector busbar between a set of hot plates to provide heat.

11. The method of claim 8, wherein the subjecting step includes applying electric current to the first and second heat-sensitive coatings to provide heat.

12. The method of claim 11, wherein the electric current is provided via placing the battery cell terminal and the interconnector busbar between a pair of electrode plates.

13. The method of claim 10, wherein a hot plate power rating for the set of hot plates is determined according to Equation (1):
$${V}_{Comp} {ρ}_{Comp} {c}_{pComp} \frac{d {T}_{Comp}}{d t} = 2 {A}_{Comp} {h}_{HotPlate} ( {T}_{HotPlate} - {T}_{Comp} ) - \frac{{T}_{Comp} - {T}_{Air}}{{R}_{Total}} \qquad ( 1 )$$
wherein: V_{Comp} stands for volume (m³) of battery cell terminals and Interconnector busbar enclosed by hot plates; ρ_{Comp} stands for average density of V_{Comp} in kg/m³ ; c_{Comp} stands for average thermal capacity of V_{Comp} in J/kg K; T_{Comp} stands transient temperature being an average temperature of V_{Comp} in K; t stands for time in s; A_{Comp} stands for contact area (m²) between a hot plate and a battery cell terminal or Interconnector busbar; h_{HotPlate} stands for heat transfer coefficient (W/m²K) between a hot plate and a battery cell terminal or Interconnector busbar on the contact area; T_{HotPlate} stands for surface temperature (K) of a hot plate at the contact interface; T_{Air} stands for room temperature (K); and R_{Total} stands for total thermal resistance (K/W) from battery cell terminal through cell to cell surfaces.

14. The method of claim 13, wherein the hot plate power rating is determined according to Equation (2) which is a first-order approximation of Equation (1):
$${V}_{Comp} {ρ}_{Comp} {c}_{pComp} \frac{d {T}_{Comp}}{d t} \approx 2 {\dot{Q}}_{HotPlate} \qquad ( 2 )$$
wherein \dot{Q}_{HotPlate} stands for hot plate power (W).

15. The method of claim 14, wherein the transient temperature T_{Comp} is determined according to Equation (3) which is obtained by integrating Equation (2) with value T_{Comp} of T_{Air} at t=0:
$${T}_{Comp} \approx \frac{2 {\dot{Q}}_{HotPlate} t}{{V}_{Comp} {ρ}_{Comp} {c}_{pComp}} + {T}_{Air} \qquad ( 3 )$$

16. The method of claim 13, wherein one or more of composite properties are determined according to one or more of Equations (4) to (9):
$$\begin{matrix} {ρ}_{Comp} = {ρ}_{Int} {V}_{Int} / {V}_{Comp} + 3 {ρ}_{Term} {V}_{Term} / {V}_{Comp} + 8 {ρ}_{Plating} {V}_{Plating} / {V}_{Comp} & ( 4 ) \\ {V}_{Comp} = {A}_{Comp} ( {t}_{Int} + 3 {t}_{Term} + 8 {t}_{Plating} ) & ( 5 ) \\ {c}_{pComp} = {c}_{pInt} {m}_{Int} / {m}_{Comp} + 3 {c}_{pTerm} {m}_{Term} / {m}_{Comp} + 8 {c}_{p Plating} {m}_{Plating} / {m}_{Comp} & ( 6 ) \\ {V}_{Int} = {A}_{Comp} {t}_{Int} {V}_{Term} = {A}_{Comp} {t}_{Term} {V}_{Plating} = {A}_{Comp} {t}_{Plating} & ( 7 ) \\ {m}_{int} = {V}_{Int} {ρ}_{Int} {m}_{Term} = {V}_{Term} {ρ}_{Term} {m}_{Plating} = {V}_{Plating} {ρ}_{Plating} & ( 8 ) \\ {m}_{Comp} = {m}_{Int} + 3 {m}_{Term} + 8 {m}_{Plating} & ( 9 )\end{matrix}$$
wherein t_{Int}, t_{Term}, t_{Plating} stands for thickness (m) of Interconnector busbar, battery cell terminal, and Sn plating, respectively; V_{Int}, V_{Term}, V_{Platin} stands for volume (m³) of interconnector busbar, battery cell terminal, and the electroplated coating, respectively; ρ_{Int}, ρ_{Term}, ρ_{Plating} stands for density (kg/m³) of interconnector busbar, battery cell terminal, and the electroplated coating, respectively; c_{pInt}, c_{pTerm}, c_{pPlating} stands for thermal capacity (J/kg·K) of interconnector busbar, battery cell terminal, and the electroplated coating, respectively; m_{Int}, m_{Term}, m_{Planting} stands for mass (kg) of interconnector busbar, battery cell terminal, and electroplated coating, respectively; and m_{Comp} stands for mass (kg) of battery cell terminals and interconnector busbar enclosed by hot plates.

17. The method of claim 14, wherein time, t_{Tm}, needed for the melting temperature Tₘ to be reached, is determined according to Equation (10):
t_{T}_{ₘ}≈(Tₘ−T_{Air})(V_{Comp}ρ_{Comp}c_{pComp})/(2\dot{Q}_{HotPlate}) (10)

18. The method of claim 17, wherein time, t_{L}, needed for heat-sensitive coatings to be completely melt is determined according to Equation (11):
t_{L}=ΔHₘnm_{Plating}/(2\dot{Q}_{HotPlate}) (11)
wherein ΔHₘ stands for latent heat of fusion (kJ/kg) of electroplated coating and n stands for number of the coating layers.

19. The method of claim 13, wherein a maximum temperature at a cell edge of the battery cell terminal is determined according to Equation (12):
$${V}_{Rest} {ρ}_{Rest} {c}_{pRest} \frac{d {T}_{Pouch}}{d t} \approx {K}_{Rest} {A}_{Cross} \frac{{T}_{Interface} - {T}_{Pouch}}{{L}_{Boundary}} \qquad ( 12 )$$
wherein V_{Rest} stands for volume (m³) of battery cell terminals & their electroplated coating layers outside the enclosed volume; ρ_{Rest} stands for density (kg/m³) of battery cell terminals & their electroplated coating layers outside the enclosed volume; c_{pRest} stands for thermal capacity (J/kg·K) of battery cell terminals & their electroplated coating layers outside the enclosed volume; T_{Pouch} stands for temperature (K) of battery cell terminals at cell pouch edge, same as the average temperature of V_{Rest}; K_{Rest} stands for thermal conductivity (W/m·K) of battery cell terminals & their electroplated coating layers; A_{Cross} stands for cross-section area (m²) of battery cell terminals & their electroplated coating layers; T_{Interface} stands for temperature (K) of battery cell terminals at the boundary of the enclosed volume, same as T_{Comp}; and L_{Boundary} stands for thickness (m) of the boundary layer between the enclosed and outside volumes.

20. A battery cell module comprising:
a battery cell terminal including a terminal substrate;
an interconnector busbar including a busbar substrate; and
a first coating of a metal M1 and second coating of a metal M2 disposed between the terminal substrate and the busbar substrate, the first coating contacting the terminal substrate, and the second coating contacting the busbar substrate, wherein the terminal substrate has a melting temperature greater than a melting temperature of the first coating, the battery cell terminal being connected to the interconnector busbar via one or more M1-M2 metallurgical bonds.
